(19) United States
(12) Patent Application Publication
(10) Pub. No.: US 2018/0334963 A1
(43) Pub. Date: Nov. 22, 2018

(54) SYSTEMS AND METHODS FOR BOWED ROTOR START MITIGATION

(71) Applicant: General Electric Company, Schenectady, NY (US)

(72) Inventors: Christian Michael Fernholz, Liberty Township, OH (US); Thomas Anthony Bonser, Cincinnati, OH (US)

(21) Appl. No.: 15/601,196

(22) Filed: May 22, 2017

(51) Int. Cl. F02C 7/275; H02K 7/14; H02P 1/04

(52) U.S. Cl. CPC F02C 7/275; H02K 7/14; H02P 1/04; F05D 2270/303; F05D 2270/114; F05D 2270/334; F05D 2260/96

(57) ABSTRACT

A rotatable machine includes a rotor, a start motor mechanically coupled to the rotor, and a controller. The controller is configured to receive an engine start signal, operate the rotor, via the start motor, at an initial rotational speed that is less than a first rotational speed associated with a first resonance frequency of the rotor, operate the rotor at less than the initial rotational speed for a predetermined time period, and operate the rotor, after the predetermined time period, at an increased rotational speed.

### BACKGROUND

The present disclosure relates generally to rotatable machines and, more specifically, to systems, methods, and computer-readable articles of manufacture for mitigating the formation of thermal rotor bow in rotatable machines.

Many known rotatable machines, such as turbofan engines and other rotating systems, experience several different phases of operation including, but not limited to, startup, warmup, steady-state, shutdown, and cool-down. Turbofan engines may cycle through the different phases of operation several times a day depending on the use of the aircraft in which the turbofan engines are attached. For example, a commercial passenger aircraft typically shuts down its engines in between flights for safety purposes as passengers disembark from the aircraft. As such, residual heat remains in the aircraft's engines, which can cause a phenomenon known as thermal rotor bow. Thermal rotor bow is generally defined by deformation in the rotating components of the turbofan engine, such as the rotating drive shafts. Deformation in the rotating components of the turbofan engine can result in performance deterioration due to rubs and/or contact-related damage between the rotating and stationary components of the turbofan engine during engine startup, thereby reducing the service life of the turbofan engine.

Thermal rotor bow is especially prominent at times after engine shutdown, and before the engine is allowed to fully cool. Moreover, many known turbofan engines are unable to naturally mitigate thermal rotor bow during startup as the design of modern commercial turbofans shifts towards longer rotor lengths, reduced rotor diameters, and higher engine operating temperatures. More specifically, increasing the length-to-diameter ratio of the turbofan engines facilitates reducing the resonant frequency of the rotating assembly to potentially below engine idle speed. In the presence of thermal rotor bow, this will produce a vibratory response during engine startup. Such a vibratory response may cause unwanted aircraft-level effects in addition to physical damage to engine components. One known method of mitigating thermal rotor bow is to motor the turbofan engine with a starter motor to lessen the severity of the rotor bow prior to fuel introduction and subsequent progression to idle. However, motoring the turbofan engine with the starter motor during startup can be a time-consuming and inconvenient process. Another known method of mitigating thermal rotor bow is to introduce a cooling fluid into one of the compressor bleed ports to displace heated air within the engine. However, cooling fluid introduced into the compressor bleed port often is not channeled to a proper location in the gas turbine engine to be able to facilitate mitigating thermal rotor bow.

### BRIEF DESCRIPTION

In one aspect, a rotatable machine is provided. The rotatable machine includes a rotor, a start motor mechanically coupled to the rotor, and a controller. The controller is configured to receive an engine start signal, operate the rotor, via the start motor, at an initial rotational speed that is less than a first rotational speed associated with a first resonance frequency of the rotor, operate the rotor at less than the initial rotational speed for a predetermined time period, and operate the rotor, after the predetermined time period, at an increased rotational speed.

In various embodiments, the controller is further configured to operate the rotor, after the predetermined time period, at the increased rotational speed corresponding to an ignition speed of the rotor and/or to operate, after operating the rotor at the increased rotational speed, the rotor at less than the increased rotational speed for another predetermined time period. In addition, in some embodiments, the controller is further configured to receive a time since shutdown signal, wherein the time since shutdown signal indicates an amount of time that has elapsed since the rotatable machine was shutdown. Further still, the controller may be configured to determine that the amount of time that has elapsed since the rotatable machine was shutdown is less than a threshold time period, and/or to operate the rotor at the initial rotational speed in response to determining that the amount of time that has elapsed since the rotatable machine was shutdown is less than the threshold time period.

In some embodiments, the controller is also configured to receive at least one of a core temperature signal, a core speed signal, a residual exhaust gas temperature signal, and a vibration signal, wherein the core temperature signal indicates a core temperature of the rotatable machine, the core speed signal indicates a core speed of the rotatable machine, the residual exhaust gas temperature signal indicates an exhaust gas temperature of the rotatable machine, and the vibration signal indicates a vibratory response of the rotor. The controller may also be configured to operate the rotor based on at least one of the core temperature signal, the core speed signal, the residual exhaust gas temperature signal, and the vibration signal.

In another aspect, an article of manufacture is provided. The article of manufacture includes a non-transitory, tangible, computer readable storage medium having instructions stored thereon that, in response to execution by a controller configured for mitigating rotor bow of a rotor in a rotatable machine, cause the controller to perform operations including: receiving an engine start signal, operating, via a start motor of the rotatable machine, the rotor at an initial rotational speed that is less than a first rotational speed associated with a first resonance frequency of the rotor, operating the rotor at less than the initial rotational speed for a predetermined time period, and operating, after the predetermined time period, the rotor at an increased rotational speed.

In various embodiments, the instructions further cause the controller to perform operations including operating, after the predetermined time period, the rotor at the increased rotational speed corresponding to an ignition speed of the rotor, and/or operating, after operating the rotor at the increased rotational speed, the rotor at less than the increased rotational speed for another predetermined time period. In some embodiments, the instructions further cause the controller to perform operations including receiving a time since shutdown signal, wherein the time since shutdown signal indicates an amount of time that has elapsed since the rotatable machine was shutdown, determining that the amount of time that has elapsed since the rotatable machine was shutdown is less than a threshold time period, and operating the rotor at the initial rotational speed in response to determining that the amount of time that has elapsed since the rotatable machine was shutdown is less than the threshold time period.

In addition, in various embodiments, the instructions further cause the controller to perform operations including receiving at least one of a core temperature signal, a core speed signal, a residual exhaust gas temperature signal, and a vibration signal, wherein the core temperature signal indicates a core temperature of the rotatable machine, the core speed signal indicates a core speed of the rotatable machine, the residual exhaust gas temperature signal indicates an exhaust gas temperature of the rotatable machine, and the vibration signal indicates a vibratory response of the rotor. The instructions may, in addition, cause the controller to perform operations including operating the rotor based on at least one of the core temperature signal, the core speed signal, the residual exhaust gas temperature signal, and the vibration signal.

In yet another aspect, a method for mitigating rotor bow of a rotor in a rotatable machine is provided. The method includes receiving an engine start signal, operating, via a start motor of the rotatable machine, the rotor at an initial rotational speed that is less than a first rotational speed associated with a first resonance frequency of the rotor, operating the rotor at less than the initial rotational speed for a predetermined time period, and operating the rotor, after the predetermined time period, at an increased rotational speed.

In various embodiments, the method further includes operating the rotor, after the predetermined time period, at the increased rotational speed corresponding to an ignition speed of the rotor, and operating, after operating the rotor at the increased rotational speed, the rotor at less than the increased rotational speed for another predetermined time period. The method may, in addition, include receiving a time since shutdown signal, wherein the time since shutdown signal indicates an amount of time that has elapsed since the rotatable machine was shutdown. Further still, the method may include determining that the amount of time that has elapsed since the rotatable machine was shutdown is less than a threshold time period, and operating the rotor at the initial rotational speed in response to determining that the amount of time that has elapsed since the rotatable machine was shutdown is less than the threshold time period.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary rotatable machine and a control system for use with the rotatable machine;

FIG. 2 is a graph illustrating several exemplary resonance frequencies associated with the rotatable machine shown at FIG. 1;

FIG. 3 is a flowchart illustrating an exemplary process for mitigating rotor bow in the rotatable machine shown at FIG. 1; and

FIG. 4 is a graph illustrating an exemplary decrease in rotational speed of the rotatable machine shown at FIG. 1 implemented in the rotatable machine prior to ignition in the rotatable machine.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Embodiments of the present disclosure relate to systems, methods, and computer-readable articles of manufacture for bowed rotor start mitigation in a rotatable machine. For example, a controller may be coupled to the rotatable machine and configured to receive an engine start signal (e.g., from an operator of the rotatable machine) as well as a core speed signal, which may indicate a core speed of a rotor of the rotatable machine. The controller may, based upon the core speed signal, determine that the rotatable machine is stationary, and in response, operate a start motor coupled to the rotor of the rotatable machine to impart an initial rotational speed to the rotor. The initial rotational speed may be less than a first rotational speed associated with a first resonance frequency of the rotor, and the rotor may be allowed to coast down for a predetermined period of time before the start motor is operated to increase the speed of the rotor to an ignition speed. In this manner, any bow that has formed in the rotor as a result of service may be removed, such that the rotor is not allowed to rotate at the first rotational speed until the bow has been removed.

As used herein, the terms “processor” and “computer” and related terms, e.g., “processing device” and “computing device”, are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory includes, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with a user interface such as a mouse and a keyboard. Alternatively, other computer peripherals may also be used that may include, for example, but not be limited to, a scanner. Furthermore, in the exemplary embodiment, additional output channels may include, but not be limited to, a user interface monitor.

Further, as used herein, the terms “software” and “firmware” are interchangeable, and include any computer program stored in memory for execution by personal computers, workstations, clients and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

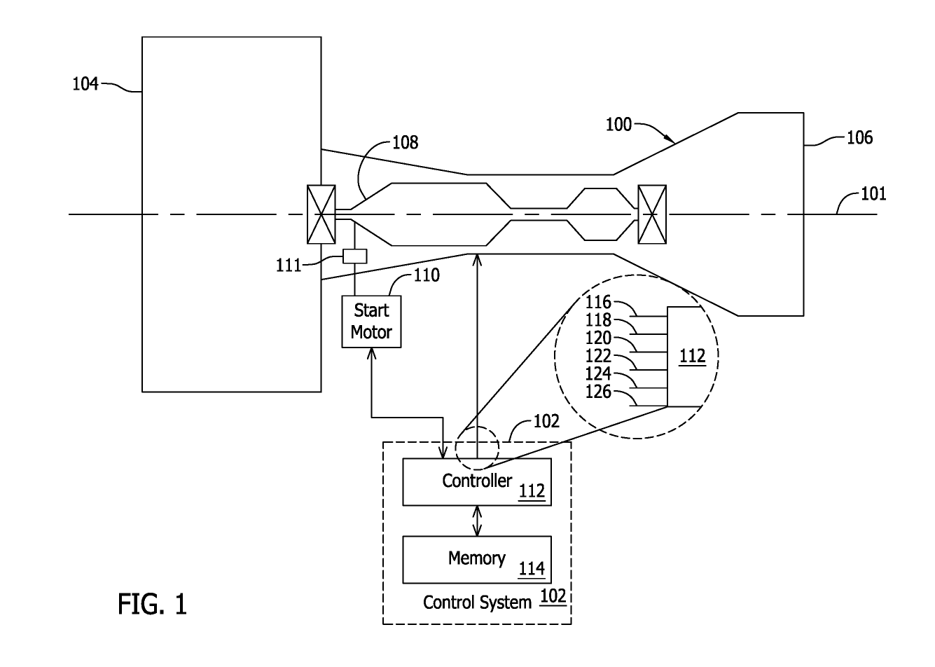

FIG. 1 is a schematic view of an exemplary rotatable machine 100 and a control system 102 for use with the rotatable machine 100. In the illustrated embodiment, rotatable machine 100 is a gas turbine engine, such as a turbofan engine for use with an aircraft. However, in alternative embodiments, rotatable machine 100 may be any other rotatable machine, such as such as any non-turbine engine, any marine engine, any aircraft engine, any terrestrial engine, and the like.

In general terms, rotatable machine 100 includes a centerline 101, an inlet 104, an outlet 106, and a rotor 108 extending between inlet 104 and outlet 106. Rotatable machine 100 also includes a start motor 110, which may be coupled to rotor 108 of rotatable machine 100 at a location suitable to impart an initial rotation to rotor 108. In various embodiments, start motor 110 is directly coupled to rotor 108. In other embodiments, start motor 110 is coupled to rotor 108 through a gearbox or a system of gears 111.

In operation, start motor 110 is engaged with rotor 108 when rotor 108 is stationary and/or rotating at a speed that is less than an ignition speed of rotatable machine 100, where the ignition speed is a minimum speed necessary for combustion of a fuel, such as jet fuel, within rotatable machine 100. As rotor 108 approaches the ignition speed, the fuel is introduced within rotatable machine 100 for combustion. After ignition, and when an acceptable sub-idle acceleration rate is obtained, start motor 110 may be disengaged from rotor 108. Thus, start motor 110 functions to impart an initial rotation to rotor 108 prior to ignition of rotatable machine 100.

Control system 102 is coupled to rotatable machine 100 and/or start motor 110 and is configured to perform operations necessary for the control of rotatable machine 100 and/or start motor 110. In some embodiments, control system 102 is a full authority digital engine control system (“FADEC”). Thus, control system 102 includes a controller 112 and a memory 114.

In the exemplary embodiment, controller 112 receives one or more of an engine start signal 116, a core speed signal 118, a time since shutdown signal 120, a core temperature signal 122, a residual exhaust gas temperature (“REGT”) signal 124, and/or a vibration signal 126. In general, engine start signal 116 indicates that an operator of rotatable machine 100 has selected an option (e.g., from a control panel, such as a control panel within a cockpit of an aircraft) to start rotatable machine 100. In addition, core speed signal 118 indicates a core speed of rotatable machine 100, such as a rotational speed of rotor 108. Moreover, time since shutdown signal 120 indicates a time since rotatable machine 100 was last shutdown (e.g., in seconds, minutes, hours, or days), and core temperature signal 122 indicates a core temperature of rotatable machine 100, such as a temperature measured from a location proximate rotor 108. In addition, REGT signal 124 indicates an exhaust gas temperature of rotatable machine 100, such as an exhaust gas temperature measured at outlet 106. Moreover, vibration signal 126 indicates a vibratory response of rotor 108. Vibration signal 126 may be used, as described herein, to determine whether rotor 108 is bowed and/or whether bow mitigation should be performed. In various embodiments, any suitable instrument may be used to measure a vibratory response of rotor 108, such as, for example, an accelerometer, a clearanceometer, and/or a proximity probe.

Memory 114 is any suitable tangible, non-transitory, computer-readable storage media to which controller 112 may be communicatively coupled. As described herein, memory 114 stores one or more computer-readable instructions, which may be executed by controller 112 for performing the operations described herein.

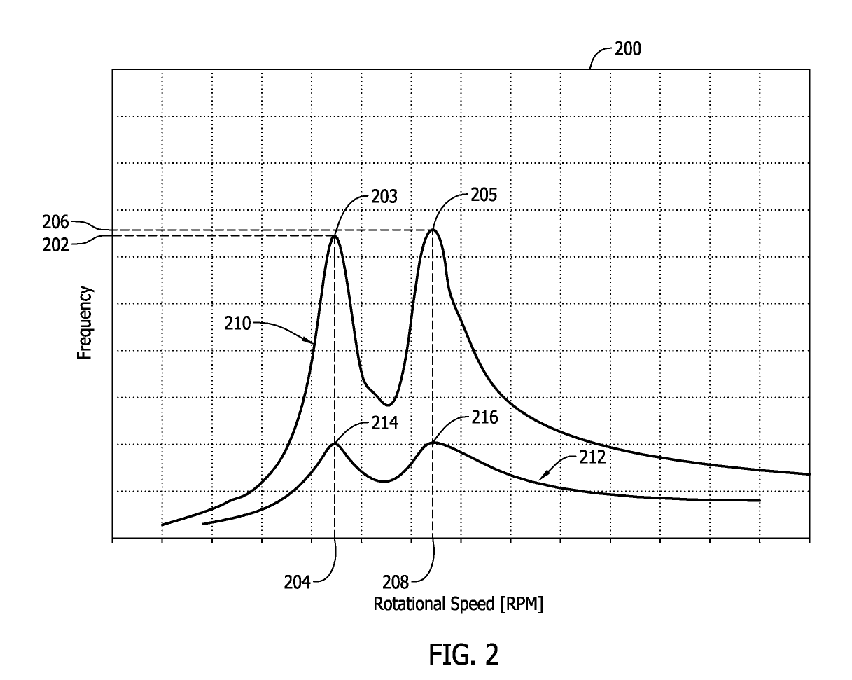

FIG. 2 is a graph 200 illustrating a first frequency response curve 210 and a second frequency response curve 212 of rotor 108 during operation. As shown with respect to first frequency response curve 210, during operation, and absent any bow mitigation (as described below) rotor 108 may experience a first resonance frequency 202 at a first rotational speed 204 of rotatable machine 100 and a second resonance frequency 206 at a second rotational speed 208 of rotatable machine 100 (shown at FIG. 1). More particularly, as described above, rotor 108 may bend or bow when rotatable machine 100 is shut down after a period of operation. During the shutdown period, residual heat in rotatable machine 100 may rise, creating a thermal gradient across rotor 108. The thermal gradient may, in turn, stress rotor 108, causing rotor 108 to adopt a curved or bowed shape that departs from or includes an angular displacement from centerline 101 of rotor 108. In a bowed condition, rotor 108 may vibrate or operate with an imbalance in rotor 108 during certain rotational speeds, such as at first rotational speed 204 and/or second rotational speed 208, and as rotor 108 encounters the first resonance frequency 202 and/or second resonance frequency 206, rotor 108 may vibrate and rub against one or more components within rotatable machine 100.

In particular, and as shown at graph 200, as rotor 108 approaches first rotational speed 204 in the bowed condition, rotor 108 may encounter a first vibrational peak 203 at first resonance frequency 202. Similarly, as rotor 108 approaches second rotational speed 208 in the bowed condition, rotor 108 may encounter a second vibrational peak 205 at second resonance frequency 206. Thus, at first resonance frequency 202, rotor 108 experiences first vibrational peak 203, which may cause rotor 108 to rub against one or more components within rotatable machine 100. Similarly, at second resonance frequency 206, rotor 108 experiences second vibrational peak 205, which may cause rotor 108 to rub against one or more components within rotatable machine 100.

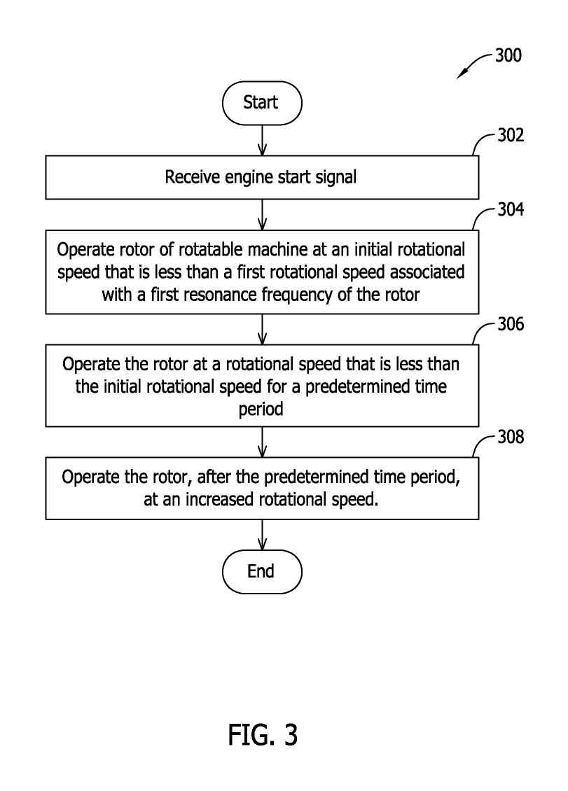

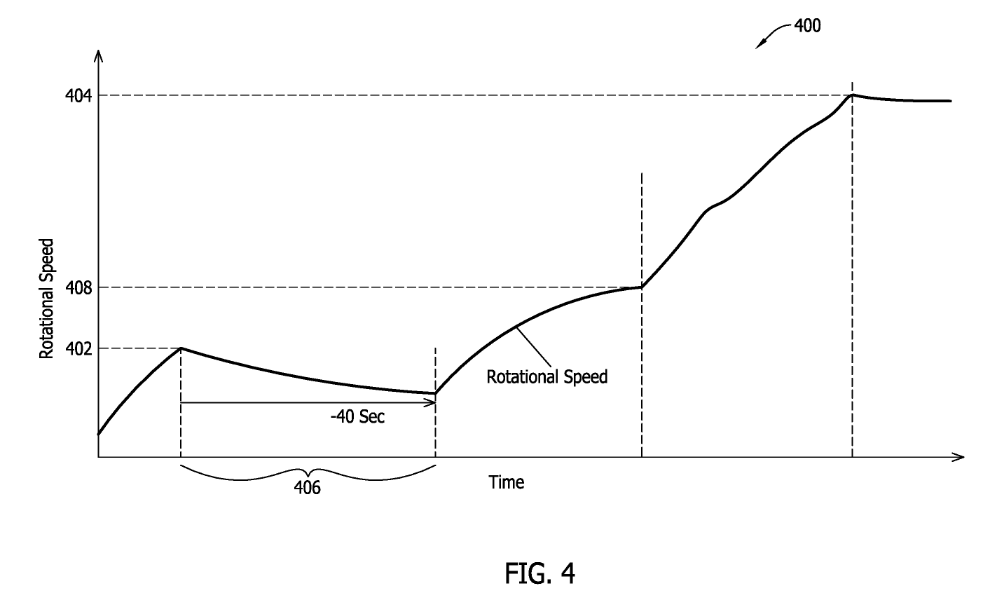

FIG. 3 is a flowchart illustrating an exemplary process 300 for mitigating a bow in rotor 108 of rotatable machine 100 (shown at FIG. 1). FIG. 4 is a graph 400 illustrating an exemplary decrease from an initial rotational speed 402 imparted, as described herein, by start motor 110 to rotor 108 of rotatable machine 100. For clarity, process 300 is described below in conjunction with graph 400 as well as with reference to graph 200 (shown in FIG. 2).

As used herein and in the description below, the term “mitigate” and the phrase “substantially mitigate” refer to a reduction in or removal of a bow from rotor 108. For example, from a functional perspective, a bow may be mitigated or substantially mitigated as a result of process 300, such that rotor 108 does not encounter first vibrational peak 203 and/or second vibrational peak 205. To this end, it may not be necessary to completely remove a bow from rotor 108 to avoid or reduce first vibrational peak 203 and/or second vibrational peak 205. Rather, a bow may be mitigated or substantially mitigated even when rotor 108 only partially returns to centerline 101, provided the return to centerline 101 is sufficient to avoid, or in some cases, to at least reduce, first vibrational peak 203 and/or second vibrational peak 205. A bow may also be mitigated or substantially mitigated, however, in the instance that rotor 108 makes a complete return to centerline 101.

In addition, although process 300 is described below with respect to a single rotatable machine 100, in various embodiments, process 300 may be applied to any number of rotatable machines simultaneously. For example, where a vehicle, such as an aircraft, includes a plurality of rotatable machines 100, process 300 may be applied to each rotatable machine 100 mounted on the vehicle simultaneously, such that rotor bow within each rotatable machine 100 of the vehicle is simultaneously mitigated.

Accordingly, controller 112 initially receives engine start signal 116 (step 302). In some embodiments, controller 112 may also receive core speed signal 118, which, as described above, may indicate a rotational speed of rotor 108. Based upon core speed signal 118, controller 112 may determine that rotor 108 of rotatable machine 100 is stationary, and as described above, where rotor 108 is stationary, a bow may have formed in rotor 108. However, in various embodiments, controller 112 does not need to determine that rotor 108 of rotatable machine 100 is stationary. Rather, controller 112 may determine, as described herein, a time since shutdown, a core temperature, and/or a residual exhaust gas temperature.

To mitigate, or substantially mitigate, a bow in rotor 108, controller 112 (in response to receiving engine start signal 116) operates start motor 110, which is mechanically coupled to rotor 108, to impart an initial rotational speed 402 to rotor 108 that is less than first rotational speed 204, where, as described above, first rotational speed 204 is associated with first resonance frequency 202 (step 304). In various embodiments, start motor 110 directly imparts initial rotational speed 402 to rotor 108. In other embodiments (as described above), start motor 110 may be coupled to rotor 108 through system of gears 111. In either case, however, rotor 108 is not permitted to rotate at a speed that would allow rotor 108 to reach first resonance frequency 202.

After start motor 110 has imparted initial rotational speed 402 to rotor 108, controller 112 allows rotor 108 to “coast down” from initial rotational speed 402 for a predetermined time period, such as a predetermined time period 406 in the range of one to two hundred seconds. For example, in some embodiments, the predetermined time period is thirty to sixty seconds. In other words, controller 112 operates rotor 108 at less than the initial rotational speed of rotor 108 (e.g., via start motor 110) for predetermined time period 406 (step 306). In the exemplary embodiment, predetermined time period 406 is approximately forty seconds, and initial rotational speed 402 is approximately twenty percent of a nominal rotational speed 404 of rotor 108 during operation of rotatable machine 100. However, in various embodiments, predetermined time period 406 is a function of a size of rotatable machine 100. For example, larger rotatable machines may be allowed to coast down for longer periods of time, and smaller rotatable machines may be allowed to coast down for shorter periods of time.

As a result of process 300, the rotational speed of rotor 108 increases to initial rotational speed 402 and coasts down for predetermined time period 406. As the rotational speed of rotor 108 increases and coasts down, any bow initially present in rotor 108 is mitigated or substantially mitigated (e.g, removed or partially removed) from rotor 108, and rotor 108 is not allowed to rotate at a speed in excess of first rotational speed 204. Thus, rotor 108 does not reach first resonance frequency 202 or second resonance frequency 206, and is not induced into a rotational condition associated with significant vibrations, such as, for example, first vibrational peak 203 and/or second vibrational peak 205.

In addition, and with returning reference to FIG. 2, in the instance that a bow in rotor 108 is reduced but not removed, the frequency response of rotor 108 may resemble second frequency response curve 212. In such a case, rotor 108 may encounter a first reduced vibrational peak 214 at first rotational speed 204 and/or a second reduced vibrational peak 216 at second rotational speed 208. However, first reduced vibrational peak 214 may be much less severe than first vibrational peak 203, and second reduced vibrational peak 216 may be much less severe than second vibrational peak 205. Thus, even where a bow is not completely removed from rotor 108 as a result of process 300, the vibrational peaks (e.g., first reduced vibrational peak 214 and second reduced vibrational peak 216) may be much less severe than the vibrational peaks (e.g., first vibrational peak 203 and second vibrational peak 205) encountered by rotor 108 absent implementation of process 300. In addition, although first reduced vibrational peak 214 is shown at graph 200 as occurring at first rotational speed 204, it will be appreciated that first reduced vibrational peak 214 may be skewed or translated to a different rotational speed as a result of process 300. Similarly, second reduced vibrational peak 216 may be skewed or translated to a different rotational speed as a result of process 300.

In addition, at the end of predetermined time period 406, controller 112 may operate rotor 108 (e.g., via start motor 110) at an increased rotational speed, relative to the rotational speed at the end of predetermined time period 406 (step 308). For example, controller 112 may cause rotor 108 to approach an ignition speed 408, as shown in FIG. 4. As rotor 108 approaches ignition speed 408, a fuel may be introduced within rotatable machine 100 for combustion. However, in some embodiments, controller 112 may alternatively introduce another predetermined time period 406 (e.g., a second predetermined time period) during which rotor 108 may be allowed to coast down for a second time. Controller 112 may, for example, permit rotor 108 to coast down from the increased rotational speed for a second predetermined time period in response to a determination that rotor 108 includes a bow after coasting down for the first predetermined time period 406. Controller 112 may, in addition, introduce more than two successive coast down time periods. For example, in various embodiments, controller 112 may introduce any number of coast down time periods suitable to mitigate a bow in rotor 108.

In various embodiments, and as described above, controller 112 may also receive one or more of time since shutdown signal 120, core temperature signal 122, REGT signal 124, and/or vibration signal 126. In response to receiving one or more of time since shutdown signal 120, core temperature signal 122, REGT signal 124, and/or vibration signal 126, controller 112 may determine whether to operate start motor 110 at initial rotational speed 402.

For example, where time since shutdown signal 120 indicates that rotatable machine 100 has been shut down for a period of time that is greater than a threshold period of time, controller 112 may not operate rotor 108 at initial rotational speed 402, because rotor 108 has been stationary for a sufficient cool-down time period to cool and straighten gradually. If, on the other hand, time since shutdown signal 120 indicates that rotatable machine 100 has been shut down for a period of time that is less than the threshold period of time, controller 112 may operate rotor 108 at initial rotational speed 402, as described above. In various embodiments, the threshold period of time to which time since shutdown signal 120 is compared is between one minute and one thousand minutes. For example, in the exemplary embodiment, the threshold period of time is six-hundred-and-sixty minutes. However, the threshold period of time may vary depending upon the specific design of rotatable machine 100.

Similarly, where core temperature signal 122 indicates that a core temperature of rotatable machine 100 is greater than a threshold core temperature, controller 112 may operate rotor 108 at initial rotational speed 402 to remove any bow formed in rotor 108 as a result of the core temperature. If, on the other hand, core temperature signal 122 indicates that a core temperature of rotatable machine 100 is less than the threshold core temperature, controller 112 may not operate rotor 108 at initial rotational speed 402, because rotor 108 may have been stationary for a period of time sufficient to cool and straighten gradually.

In addition, where REGT signal 124 indicates that a residual exhaust gas temperature of rotatable machine 100 is greater than a threshold residual exhaust gas temperature, controller 112 may operate rotor 108 at initial rotational speed 402 to remove any bow formed in rotor 108 as a result of heat remaining within rotatable machine 100. If, on the other hand, REGT signal 124 indicates that a residual exhaust gas temperature of rotatable machine 100 is less than the threshold residual exhaust gas temperature, controller 112 may not operate rotor 108 at initial rotational speed 402, because rotor 108 may have been stationary for a period of time sufficient to cool and straighten gradually.

Moreover, where vibration signal 126 indicates that rotor 108 is vibrating, controller 112 may operate rotor 108 at an initial rotation speed 402 to remove any bow formed in rotor 108, as evidenced by the vibratory response of rotor 108. If, on the other hand, vibration signal 126 indicates that rotor 108 is not vibrating, or that rotor 108 is only vibrating below a threshold level or amount of vibration, such as below first vibrational peak 203 and/or below second vibrational peak 205, controller 112 may not operate rotor 108 at initial rotational speed 402.

Embodiments of the systems, methods, and articles of manufacture, as described above, facilitate bowed rotor start mitigation in a rotatable machine. For example, a controller may be coupled to the rotatable machine and configured to receive an engine start signal (e.g., from an operator of the rotatable machine) as well as a core speed signal, which may indicate a core speed of a rotor of the rotatable machine. The controller may, based upon the core speed signal, determine that the rotatable machine is stationary, and in response, operate the rotor, via a start motor coupled to the rotor, to impart an initial rotational speed to the rotor. The initial rotational speed may be less than a first rotational speed associated with a first resonance frequency of the rotor, and the rotor may be allowed to coast down for a predetermined period of time before the start motor is operated to increase the speed of the rotor to an ignition speed. In this manner, any bow that has formed in the rotor as a result of service may be removed, such that the rotor is not allowed to rotate at the first rotational speed until the bow has been removed.

Exemplary technical effects of the systems, methods, and articles of manufacture described herein include, for example: (a) determining that a rotor of a rotatable machine is stationary; (b) in response, operating, via a start motor, a rotor of the rotatable machine at an initial rotational speed that is less than a first rotational speed associated with a first resonance frequency of the rotor; (c) reducing the rotational speed of the rotor from the initial rotational speed for a predetermined time period; and (d) increasing, after the predetermined time period, the rotational speed of the rotor to an ignition speed.

Exemplary embodiments of the systems, methods, and articles of manufacture and related components are described above in detail. The system is not limited to the specific embodiments described herein, but rather, components of systems and/or steps of the methods may be utilized independently and separately from other components and/or steps described herein. For example, the configuration of components described herein may also be used in combination with other processes, and is not limited to practice with the systems and related methods as described herein. Rather, the exemplary embodiment can be implemented and utilized in connection with many applications where controlling a rotor is desired.

Although specific features of various embodiments of the present disclosure may be shown in some drawings and not in others, this is for convenience only. In accordance with the principles of the present disclosure, any feature of a drawing may be referenced and/or claimed in combination with any feature of any other drawing.

This written description uses examples to disclose the embodiments of the present disclosure, including the best mode, and also to enable any person skilled in the art to practice the disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A rotatable machine comprising:
a rotor;
a start motor mechanically coupled to said rotor; and
a controller configured to:
receive an engine start signal;
operate said rotor, via said start motor, at an initial rotational speed that is less than a first rotational speed associated with a first resonance frequency of said rotor;
operate said rotor at less than the initial rotational speed for a predetermined time period; and
operate said rotor, after the predetermined time period, at an increased rotational speed.

2. The rotatable machine of claim 1, wherein said controller is further configured to operate said rotor, after the predetermined time period, at the increased rotational speed corresponding to an ignition speed of said rotor.

3. The rotatable machine of claim 1, wherein said controller is further configured to operate, after operating said rotor at the increased rotational speed, said rotor at less than the increased rotational speed for another predetermined time period.

4. The rotatable machine of claim 1, wherein said controller is further configured to receive a time since shutdown signal, wherein the time since shutdown signal indicates an amount of time that has elapsed since said rotatable machine was shutdown.

5. The rotatable machine of claim 4, wherein said controller is further configured to determine that the amount of time that has elapsed since said rotatable machine was shutdown is less than a threshold time period.

6. The rotatable machine of claim 5, wherein said controller is further configured to operate said rotor at the initial rotational speed in response to determining that the amount of time that has elapsed since said rotatable machine was shutdown is less than the threshold time period.

7. The rotatable machine of claim 1, wherein said controller is further configured to receive at least one of a core temperature signal, a core speed signal, a residual exhaust gas temperature signal, and a vibration signal, wherein the core temperature signal indicates a core temperature of said rotatable machine, the core speed signal indicates a core speed of said rotatable machine, the residual exhaust gas temperature signal indicates an exhaust gas temperature of said rotatable machine, and the vibration signal indicates a vibratory response of said rotor.

8. The rotatable machine of claim 7, wherein said controller is further configured to operate said rotor based on at least one of the core temperature signal, the core speed signal, the residual exhaust gas temperature signal, and the vibration signal.

9. An article of manufacture including a non-transitory, tangible, computer readable storage medium having instructions stored thereon that, in response to execution by a controller configured for mitigating rotor bow of a rotor in a rotatable machine, cause the controller to perform operations comprising:
receiving an engine start signal;
operating, via a start motor of the rotatable machine, the rotor at an initial rotational speed that is less than a first rotational speed associated with a first resonance frequency of the rotor;
operating the rotor at less than the initial rotational speed for a predetermined time period; and
operating, after the predetermined time period, the rotor at an increased rotational speed.

10. The article of claim 9, wherein the instructions further cause the controller to perform operations comprising operating, after the predetermined time period, the rotor at the increased rotational speed corresponding to an ignition speed of the rotor.

11. The article of claim 9, wherein the instructions further cause the controller to perform operations comprising operating, after operating the rotor at the increased rotational speed, the rotor at less than the increased rotational speed for another predetermined time period.

12. The article of claim 9, wherein the instructions further cause the controller to perform operations comprising receiving a time since shutdown signal, wherein the time since shutdown signal indicates an amount of time that has elapsed since the rotatable machine was shutdown.

13. The article of claim 12, wherein the instructions further cause the controller to perform operations comprising determining that the amount of time that has elapsed since the rotatable machine was shutdown is less than a threshold time period.

14. The article of claim 13, wherein the instructions further cause the controller to perform operations comprising operating the rotor at the initial rotational speed in response to determining that the amount of time that has elapsed since the rotatable machine was shutdown is less than the threshold time period.

15. The article of claim 9, wherein the instructions further cause the controller to perform operations comprising:
receiving at least one of a core temperature signal, a core speed signal, a residual exhaust gas temperature signal, and a vibration signal, wherein the core temperature signal indicates a core temperature of the rotatable machine, the core speed signal indicates a core speed of the rotatable machine, the residual exhaust gas temperature signal indicates an exhaust gas temperature of the rotatable machine, and the vibration signal indicates a vibratory response of the rotor; and
operating the rotor based on at least one of the core temperature signal, the core speed signal, the residual exhaust gas temperature signal, and the vibration signal.

16. A method for mitigating rotor bow of a rotor in a rotatable machine, said method comprising:
receiving an engine start signal;
operating, via a start motor of the rotatable machine, the rotor at an initial rotational speed that is less than a first rotational speed associated with a first resonance frequency of the rotor;
operating the rotor at less than the initial rotational speed for a predetermined time period; and
operating the rotor, after the predetermined time period, at an increased rotational speed.

17. The method of claim 16, further comprising operating the rotor, after the predetermined time period, at the increased rotational speed corresponding to an ignition speed of the rotor.

18. The method of claim 16, further comprising operating, after operating the rotor at the increased rotational speed, the rotor at less than the increased rotational speed for another predetermined time period.

19. The method of claim 16, further comprising receiving a time since shutdown signal, wherein the time since shutdown signal indicates an amount of time that has elapsed since the rotatable machine was shutdown.

20. The method of claim 19, further comprising:
determining that the amount of time that has elapsed since the rotatable machine was shutdown is less than a threshold time period; and
operating the rotor at the initial rotational speed in response to determining that the amount of time that has elapsed since the rotatable machine was shutdown is less than the threshold time period.
